(19) United States
(12) Patent Application Publication
(10) Pub. No.: US 2005/0131831 A1
(43) Pub. Date: Jun. 16, 2005

(54) Web-based digital rights management (DRM) encoder

(76) Inventor: Belin Fieldson, Portland, OR (US)

Correspondence Address: FISH & RICHARDSON, PC, 12390 EL CAMINO REAL, SAN DIEGO, CA, 92130-2081, US

(21) Appl. No.: 10/734,748

(22) Filed: Dec. 11, 2003

(51) Int. Cl. G06F 17/60

(52) U.S. Cl. 705/59

(57) ABSTRACT

A digital rights management (DRM) system includes an application service provider (ASP) that provides a gateway to a DRM engine and acts as a license clearinghouse for one or more client content providers. The ASP provides a web-based DRM encoder that enables a client to encode digital content and package (e.g., encrypt and associate digital rights) the client's content locally. The client may then serve the packaged content to customers. The ASP may monitor and control the web-based encoding and handles license generation and issuance of the licenses. License handling may include delivering the keys required by the customers to access the packaged content and tracking content distribution.

### BACKGROUND

The Internet is increasingly being used to buy, sell, and send copyrighted content (e.g., music, video, and image files) in digital form. Digital Rights Management (DRM) systems have been developed to protect digital media from unauthorized use once it is outside the control of the publisher or distributor and to track the distribution and use of the content.

In a typical DRM scheme, an individual is given rights to a piece of content based on certain conditions. For instance, the user may be allowed to view a file once, view a number of files at a website for a set period of times, or view a file on a particular machine or device. The content, if stored locally on a user's machine, is usually encrypted so it cannot be accessed without the proper authentication or key.

A provider of digital content may use a third party DRM network server to package or “wrap” the content and to create and handle license distribution. The packaging may include encrypting the content and associating digital rights with the content. However, this may require that the content be transferred to the third party server. This may be undesirable for the content provider, who may which to host the content locally and therefore prefer that the content not leave the content provider's system.

### SUMMARY

A digital rights management (DRM) system includes an application service provider (ASP) that provides a gateway to a DRM engine and acts as a license clearinghouse for one or more client content providers. The ASP provides a web-based DRM encoder that enables a client to encode digital content and package (e.g., encrypt and associate digital rights) the client's content locally. The client may then serve the packaged content to customers. The ASP may monitor and control the web-based encoding and handles license generation and issuance of the licenses. License handling may include delivering the keys required by the customers to access the packaged content and tracking content distribution.

### BRIEF DESCRIPTION OF THE DRAWINGS

FIG. 1 is a block diagram of a DRM (Digital Rights Management) system.

FIG. 2 is a screen shot of an on-line encoding station web page.

FIGS. 3A-3B show a flowchart describing a web-based local DRM encoding process.

### DETAILED DESCRIPTION

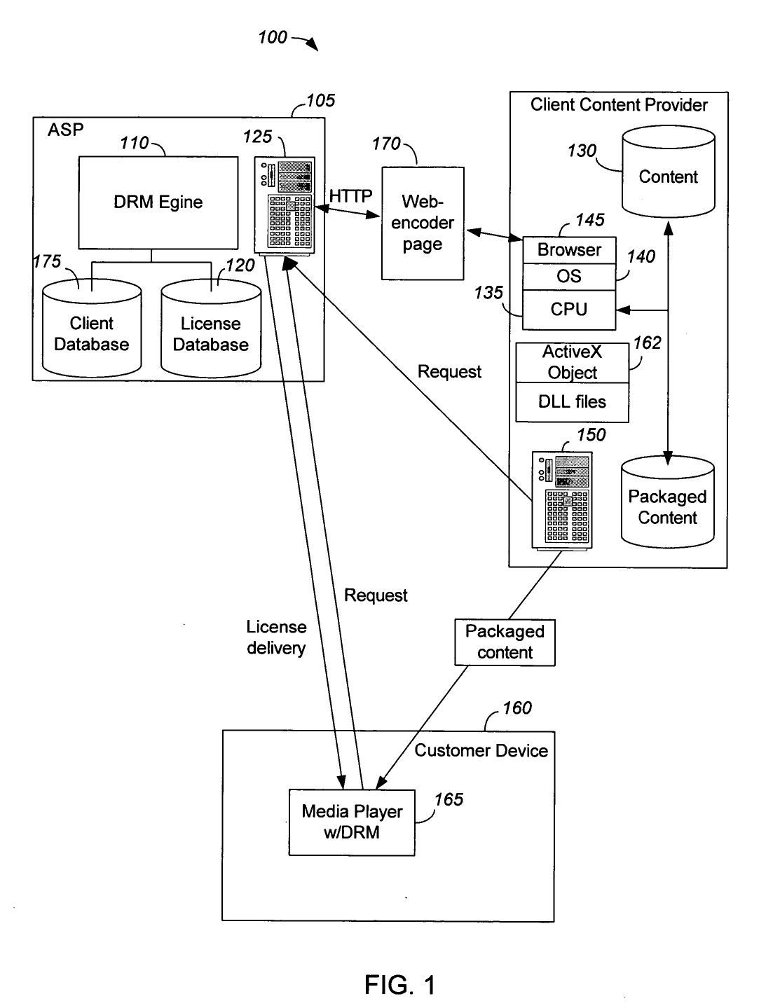

FIG. 1 shows a digital rights management (DRM) system 100 according to an embodiment. An application service provider (ASP) 105 provides a gateway to a DRM engine 110 and acts as a license clearinghouse for one or more client content providers 115. The ASP 105 provides a Web-based DRM encoder that enables a client to encode digital content and package or “wrap” (e.g., encrypt and associate digital rights) the client's content locally. The digital content may include audio, video, and image files, as well as text files, electronic books, and application and game programs. The digital content may be downloadable files or streaming media. The client may then serve the packaged content to customers. The ASP 105 may control and monitor the web-based encoding and handles license generation and issuance of the licenses. License handling may include delivering the keys required by the customers to access the packaged content and tracking content distribution.

The ASP 105 may include a license database 120 for storing license-related information, e.g., key ID, license seed key, rights and conditions of licenses, and custom attributes (name/value pairs) such as a description of the license. The ASP 105 may also include a web server 125 for hosting the license management and controlling the web-based encoder. The DRM engine 110 includes applications for packaging content and managing rights. In an embodiment, the DRM engine is a Microsoft® Windows Media® Digital Rights Management (DRM) system and includes DRM programs developed using the Windows Media Rights Manager Software Development Kit (SDK).

The client content provider 115 may include a storage device 130, including unencoded and unpackaged digital content, a CPU (Central Processing Unit) 135, an operating system (OS) 140, a browser 145 for communicating over the Internet, and a web server 150 for hosting packaged content.

A customer device 160, e.g., a web-enabled personal computer (PC) or portable device, includes a media player 165 that supports the DRM system utilized by the ASP 105 and client content provider 115.

The client content provider 115 may use the web-based encoder to encode and package digital content locally, i.e., at the client content provider's site. A software package 162 may be installed on the client content provider to enable the web-based encoder. The installation package 162 may include code for calling and running the web-based encoder. In an embodiment, the installation package includes an ActiveX object and encoder specific DLL (dynamic link library) and/or EXE (executable) files. For example, for the Microsoft® Windows Media® Digital Rights Management (DRM) system, the DLLs stored on the client content provider may include enrollobj.dll, wmrmobjs.dll, commdlg32.ocx, and shdocvw.dll, several of which may be integral to a Windows-based operating system. Once installed, the ActiveX object may be used to open a web page 170 hosted by the ASP's web server 125.

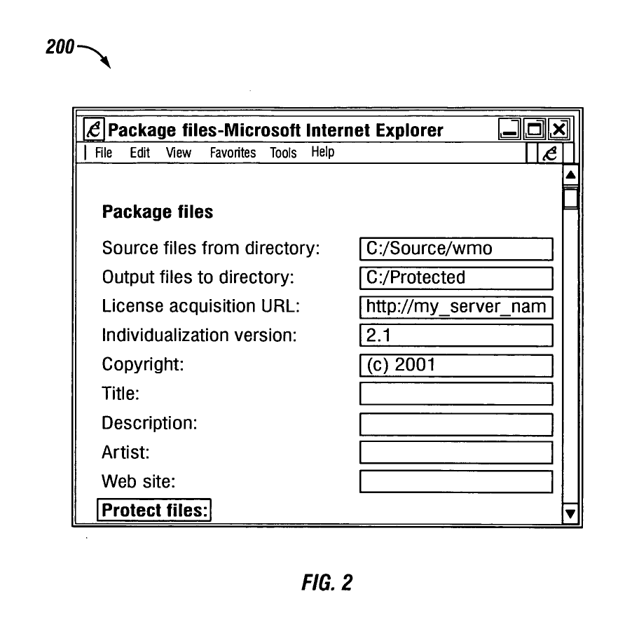

The web page 170 may present a display screen with fields that allow the user to enter the names of digital content files to be encoded and packaged. FIG. 2 shows an exemplary display screen 200 with such fields. The server may control the local encoding process using SOAP (Simple Object Access Protocol) commands coming through the HTTP (Hypertext Transfer Protocol) interface with the web page 170. SOAP is a protocol that enables a program running in one kind of operating system (such as Windows 2000) to communicate with a program in the same or another kind of an operating system (such as Linux) using HTTP and XML (Extensible Markup Language) as the mechanisms for information exchange. Since Web protocols are installed and available for use by all major operating system platforms, HTTP and XML provide an already at-hand solution to the problem of how programs running under different operating systems in a network can communicate with each other. SOAP specifies how to encode an HTTP header and an XML file so that a program in one computer can call a program in another computer and pass it information. It also specifies how the called program can return a response.

The web page 170 may open the selected content files in the field using, e.g., a “commdialog” control. The web-based encoder, run as an ActiveX object embedded in the web page, may encode the digital content and package the encoded content. The files may be encoded and packaged into a desired digital format (e.g., WMF (Windows Media Format)) using library objects in response to data and/or commands from the server over the HTTP interface.

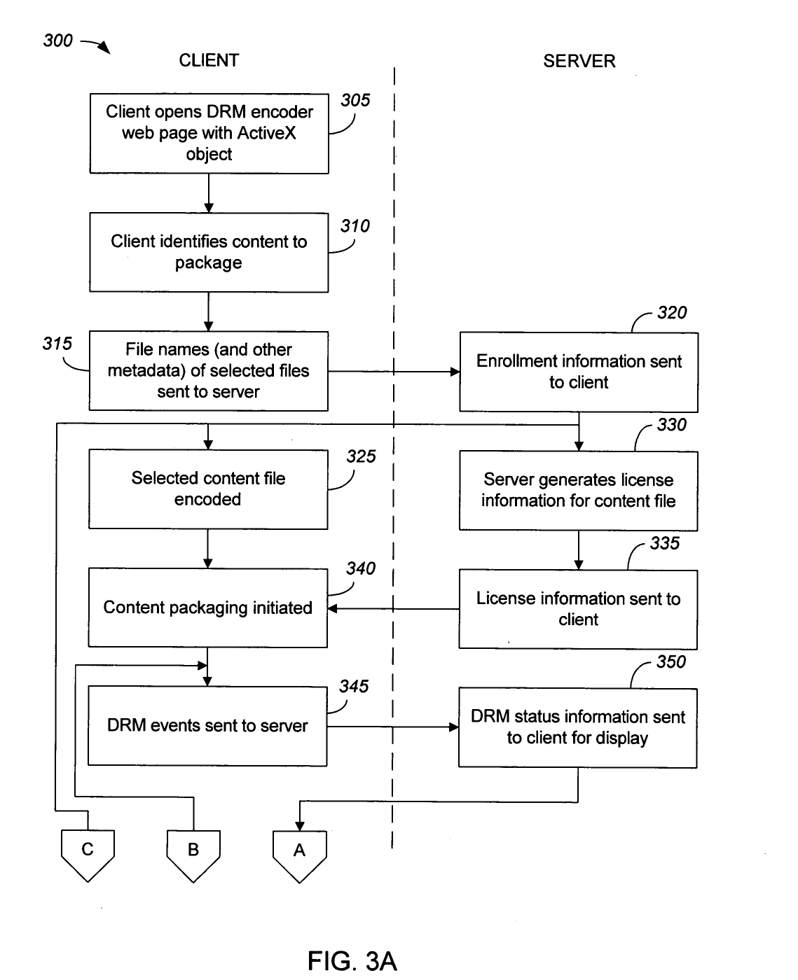

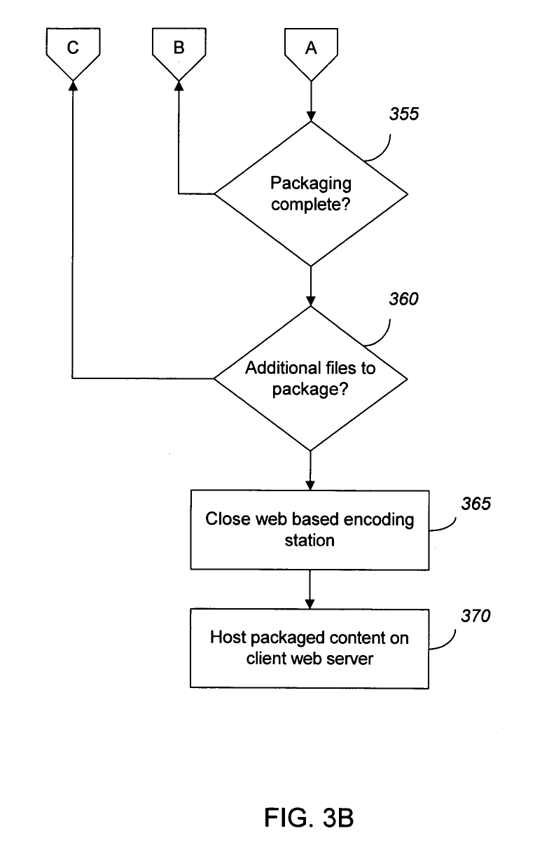

FIG. 3 is a flowchart describing a web-based local encoding process 300 according to an embodiment. As shown in the flowchart, steps in the process may be performed in parallel at the client 115 and server 105. A user at the client 115 may open the web page portal to the on-line encoder using the ActiveX object (block 305). The user may first login to the on-line encoding station. The web page may then provide a display screen, such as that shown in FIG. 2, which enables the user to select files to encode and set names corresponding the encoded files to be created (block 310). The file names may be sent to the ASP 105 over the HTTP link via SOAP commands (block 315).

The ASP 105 identifies the information from the client 115 as a request for a web-based DRM encoding session. In an embodiment, the encoding application may require enrollment information from the party intending to encode files. The ASP 105 may store this information in a client database and send it to the client when the user activates the on-line encoder (block 320). The web page may open the file to encode using a commdialog command and then encode the file in a desired format using the ActiveX object and library objects at the client (block 320).

The DRM engine 110 at the ASP 105 may generate a key ID for the file, and then retrieve a license key seed associated with the particular client content provider. The DRM engine 110 may generate a key for the file using the key ID and the license key seed. The ASP 105 may also generate content header information (e.g., the key ID, content ID, license acquisition URL, and attributes). The ASP 105 may then send the key and content header for the file to the client via the HTTP interface of the web page (block 330). The ASP 105 may store the key and content header information along with rights information in a database.

The ActiveX object at the client 115 may then begin packaging the encoded file using the information from the ASP 105, i.e., the key and content header (block 340). During the packaging operation, the ActiveX object may send DRM events to the ASP 105 via the SOAP interface (block 345). The DRM engine at the ASP 105 may interpret the DRM events and send corresponding status information (e.g., starting, percent complete, finishing) back to the client via the web link for display to the user (block 350). The DRM events are sent between the client and server until the packaging process is complete (block 355). When all of the selected files are encoded and packaged (block 360), the web page is closed (block 365). The encoded and packaged file may then be stored on the client web server for hosting to customers (block 370).

In an embodiment, the encoding object supports a variety of properties, allowing the web page it is embedded in to make changes to the encoding settings of a file. Available properties may include:

SetSeed(Seed As String)
SetRegPage(regPage As String)
SetKey(Optional kid As String)
GetSeed ( )
GetHeader ( )
SetContentServerPrivKey (cspvk As String)
SetContentServerPubKey (cspbk As String)
SetInputFile (inputFileName As String)
SetOutputFileName (output FileName As String)

The system may support pre-delivery and/or post-delivery of licenses. For pre-delivery, the license may be delivered just before playback for each object being played. When the customer 160 selects and gains authorization to access a file (e.g., by paying a fee or entering registration information), the client content provider 115 may send a request to the ASP 105 including the content header information of the file and the customer's address (e.g., IP address). The ASP 105 may then generate a license from the license seed key for the client content provider and the key ID in the content header and deliver the license directly to the customer's machine prior to the customer downloading or streaming the file. The DRM-capable media player on the customer's machine may then use the license to access the encrypted digital content file. Alternatively, the media player may use the license URL in the content header to send the request directly to the ASP 105.

Although the encoding object is described as an ActiveX object, the object may be produced using other programming languages, such as Java.

The computer programs (also known as programs, software, software applications or code) described herein may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiments have been described. Nevertheless, it will be understood that various modifications may be made without departing from the spirit and scope of the invention. For example, blocks in the flowcharts may be skipped or performed out of order and still produce desirable results. Accordingly, other embodiments are within the scope of the following claims.

1. A method comprising:
at a client,
storing digital content;
opening a web page include a web-based encoder object;
transmitting information identifying the digital content to a digital rights management server;
encoding the digital content;
receiving license information from the digital rights management server;
packaging the encoded digital content with the web-based encoder object and the license information; and
hosting the packaged digital content at a client server.

2. The method of claim 1, wherein the web-based encoder object comprises an ActiveX object.

3. The method of claim 1, wherein said encoding comprises receiving enrollment information associated with the client from the digital rights management server; and
providing said enrollment information to the web-based encoder object.

4. The method of claim 1, wherein the information identifying the digital content comprises a name associated with the digital content and a name to be associated with the packaged digital content.

5. The method of claim 1, wherein the license information comprises a key and a content header.

6. The method of claim 5, wherein the content header includes a license acquisition URL and attributes associated with a license.

7. The method of claim 5, further comprising:
downloading the packaged digital content to a customer client; and
sending a license request to the digital rights management server including the content header information and an address associated with the customer client.

8. A method comprising:
hosting a web page including a web-based encoder object;
receiving information associated with digital content at a client from the client;
generating a license key for said digital content;
generating a content header for said digital content;
transmitting the license key and the content header to the client; and
monitoring a web-based encoding and packaging of the digital content at the client by the web-based encoder object from the web-based encoder object.

9. The method of claim 8, wherein the web-based encoder object comprises an ActiveX object.

10. The method of claim 8, wherein said monitoring comprises receiving digital rights management events from the web-based encoder object during said encoding and packaging of the digital content.

11. The method of claim 10, further comprising receiving said events through a SOAP interface.

12. The method of claim 10, further comprising sending status information to the client in response to said events.

13. The method of claim 8, further comprising transmitting enrollment information associated with the client to the client.

14. The method of claim 8, wherein said generating the license key comprises:
generating a key ID for the digital content; and
retrieving a license key seed associated with the client.

15. The method of claim 8, further comprising:
generating a license for the packaged digital content in response to a request from one of the client and a customer client; and
downloading the license to the customer client.

16. A system comprising:
a network connection for communication with a client;
a server to host a web page including a web-based encoder object; and
a digital rights management (DRM) engine to, in response to receiving information associated with digital content at the client from the client:
generate a license key for said digital content;
generate a content header for said digital content;
transmit the license key and the content header to the client; and
monitor a web-based encoding and packaging of the digital content at the client by the web-based encoder object from the web-based encoder object.

17. The system of claim 8, wherein the web-based encoder object comprises an ActiveX object.

18. The system of claim 16, wherein the DRM engine is further operative to:
receive DRM events from the web-based encoder object during said encoding and packaging of the digital content; and
send status information to the client in response to said events.

20. The system of claim 16, wherein the network connection comprises a SOAP interface.

21. The system of claim 16, wherein the DRM engine is further operative to transmit enrollment information associated with the client to the client.

22. The system of claim 16, further comprising:
a client database including a license key seed associated with the client.

23. The system of claim 22, wherein the DRM engine is further operative to:
generating a key ID for the digital content; and
retrieving a license key seed associated with the client.

24. The system of claim 16, further comprising:
a license database including a license associated with the digital content, and
wherein the DRM engine is further operative to:
generating a license for the packaged digital content in response to a request from one of the client and a customer client; and
downloading the license to the customer client using the network connection.

25. An article comprising a machine-readable medium including machine-executable instructions to control a machine to:
at a client,
store digital content;
open a web page include a web-based encoder object;
transmit information identifying the digital content to a digital rights management server;
encode the digital content;
receive license information from the digital rights management server;
package the encoded digital content with the web-based encoder object and the license information; and
host the packaged digital content at a client server.

26. An article comprising a machine-readable medium including machine-executable instructions to control a machine to:
host a web page including a web-based encoder object;
receive information associated with digital content at a client from the client;
generate a license key for said digital content;
generate a content header for said digital content;
transmit the license key and the content header to the client; and
monitor a web-based encoding and packaging of the digital content at the client by the web-based encoder object from the web-based encoder object.
